(19) United States
(12) Patent Application Publication
(10) Pub. No.: US 2026/0212250 A1
(43) Pub. Date: Jul. 23, 2026

(54) EXECUTION OF QUANTUM NEURAL NETWORKS ON DUAL-HELIX QUANTUM ARCHITECTURES

(71) Applicant: Homatch.ai, Milpitas, CA (US)

(72) Inventor: Mingjun Wang, Saratoga, CA (US)

(21) Appl. No.: 19/455,619

(22) Filed: Jan. 21, 2026

Related U.S. Application Data
(60) Provisional application No. 63/748,910, filed on Jan. 23, 2025.
(60) Provisional application No. 63/749,253, filed on Jan. 24, 2025.
(60) Provisional application No. 63/753,176, filed on Feb. 3, 2025.
(60) Provisional application No. 63/753,181, filed on Feb. 3, 2025.

(51) Int. Cl. G06N 10/60

(52) U.S. Cl. CPC G06N 10/60

(57) ABSTRACT

A method may include obtaining a quantum neural network with a plurality of network layers and assigning each network layer of the plurality of network layers to a distinct set of quantum nodes physically arranged along two intertwined helices extending along a longitudinal axis of a quantum computing architecture such that adjacent network layers of the plurality of network layers are assigned to sets of quantum nodes on different ones of the two intertwined helices. The method may also include performing one or more quantum computations using the quantum computing architecture.

### RELATED APPLICATIONS

This application claims the benefit of and priority to U.S. Provisional Application No. 63/749,253 filed on Jan. 24, 2025, U.S. Provisional Application No. 63/753,176 filed on Feb. 3, 2025, U.S. Provisional Application No. 63/753,181 filed on Feb. 3, 2025, and U.S. Provisional Application No. 63/748,910 filed on Jan. 23, 2025, the entire contents of which are hereby incorporated by reference in their entireties.

### TECHNICAL FIELD

The present disclosure relates to execution of quantum neural networks on dual-helix quantum architectures.

### BACKGROUND

Unless otherwise indicated herein, the materials described herein are not prior art to the claims in the present application and are not admitted to be prior art by inclusion in this section.

Quantum computing systems utilize quantum mechanical phenomena such as superposition and entanglement to perform computations that may be infeasible for classical computing systems. As quantum hardware scales, architectural organization, routing efficiency, and execution coordination become increasingly significant challenges.

Artificial intelligence workloads, including neural network training, optimization, and inference, impose additional demands on quantum computing systems. Such workloads often require repeated parameter updates, structured data flow, parallel execution, and coordination between quantum and classical processing components. Conventional planar quantum architectures may encounter limitations in scalability, routing complexity, and execution efficiency when applied to these workloads.

Accordingly, there is an ongoing need for quantum computing architectures and execution frameworks that improve spatial organization, support parallel execution, and provide flexibility for a wide range of quantum algorithms and artificial intelligence workloads.

The subject matter claimed herein is not limited to embodiments that solve any particular disadvantages or that operate only in environments such as those described above. Rather, this background is only provided to illustrate example technology contexts in which embodiments described herein may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

In some embodiments, a method includes obtaining a quantum neural network having a plurality of network layers and assigning each network layer to a distinct set of quantum nodes physically arranged along two intertwined helices extending along a longitudinal axis of a quantum computing architecture such that adjacent network layers are assigned to sets of quantum nodes on different ones of the two intertwined helices. The method further includes performing one or more quantum computations using the quantum computing architecture.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION

The present application may be better understood by reference to the embodiments described below taken in conjunction with the accompanying drawing figures, in which like parts are referred by like numerals.

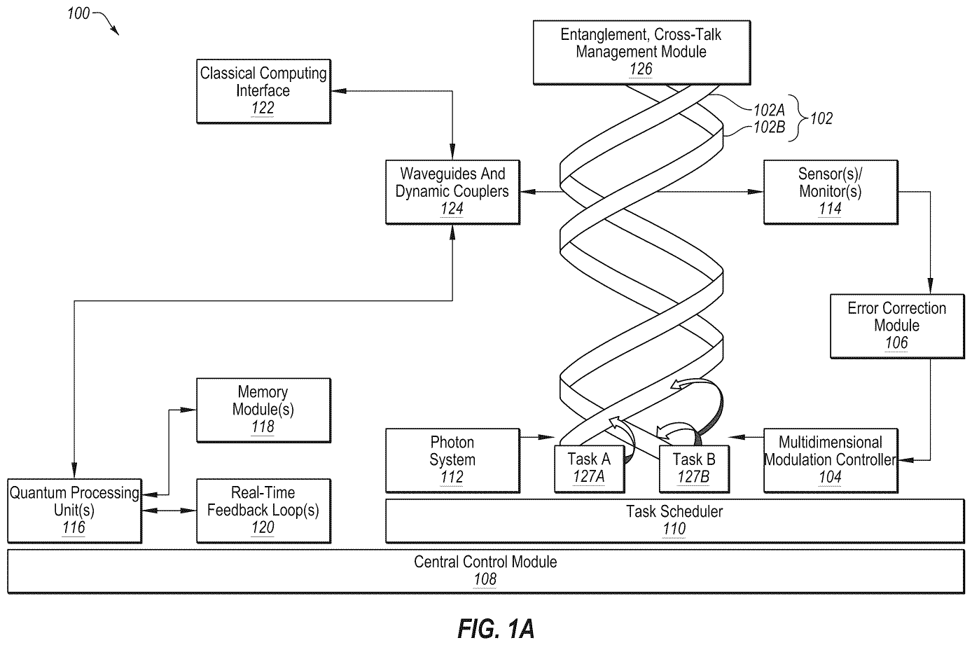

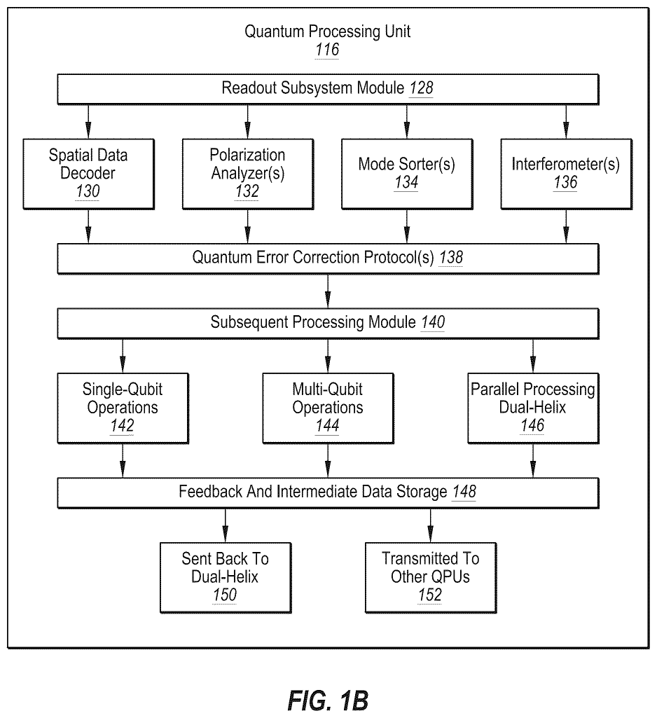

FIG. 1A illustrates an example quantum computing system that includes a dual-helix quantum architecture.

FIG. 1B illustrates an example implementation of a quantum processing unit (QPU) included in the quantum computing system of FIG. 1A.

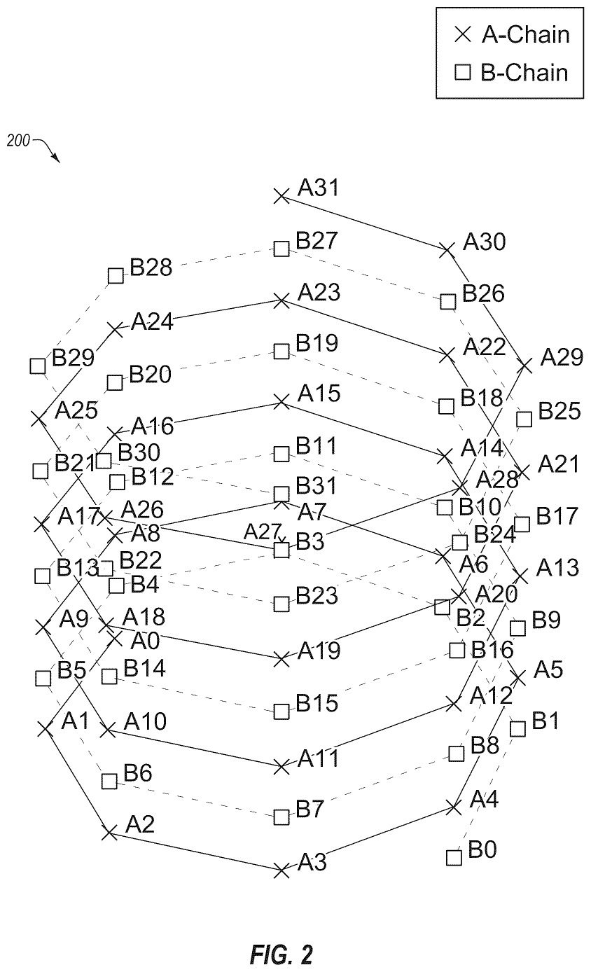

FIG. 2 is a view of an example dual-helix quantum architecture showing interleaved A-helix chain and B-helix chain quantum nodes.

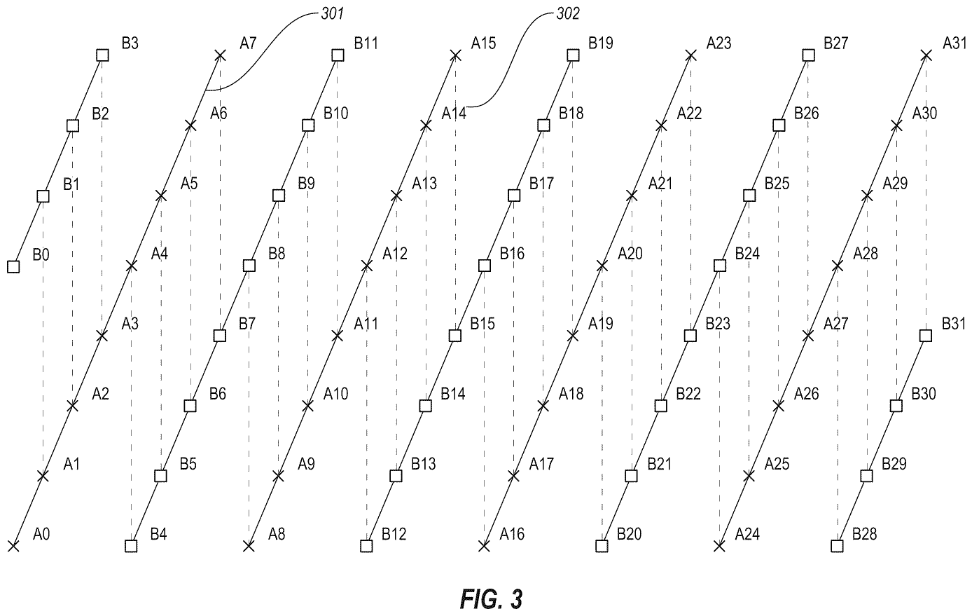

FIG. 3 is a view illustrating an example spiral-unwrapped placement of quantum nodes on the A-helix chain and B-helix chain, together with quantum links between the quantum nodes.

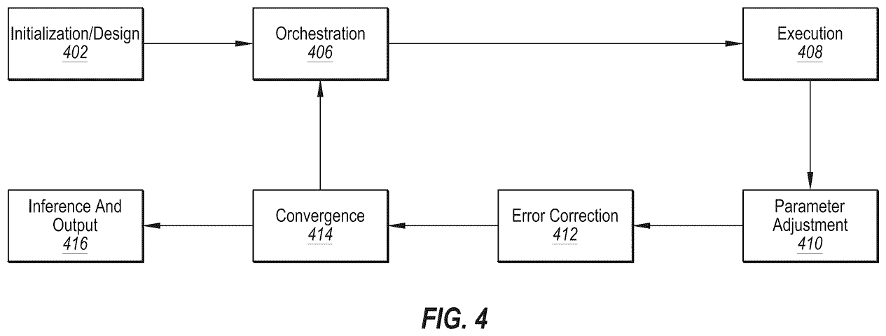

FIG. 4 illustrates an example process flow for quantum computing using a dual-helix quantum architecture.

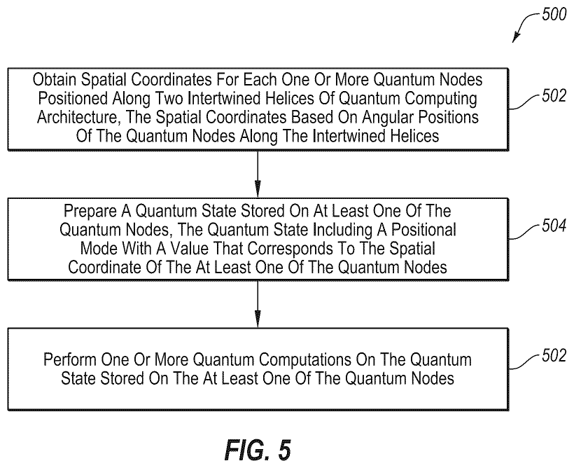

FIGS. 5-9 depict flowcharts of example methods of quantum computing.

### DETAILED DESCRIPTION

To provide a more thorough understanding of various embodiments of the present invention, the following description sets forth numerous specific details, such as specific configurations, parameters, examples, and the like. It should be recognized, however, that such description is not intended as a limitation on the scope of the present invention but is intended to provide a better description of the exemplary embodiments.

The field of quantum computing has seen significant advancements in recent years. However, several challenges remain in the development of practical and scalable quantum computing systems. These challenges may include limitations in computational capacity, storage efficiency, and error correction mechanisms.

Some quantum computing architectures rely on single-dimensional binary encoding or limited state modulation techniques. These approaches may face constraints when handling large-scale computations or complex quantum operations, such as computations associated with artificial intelligence (AI). These challenges highlight the need for innovative approaches in quantum computing architecture. Advancements in these areas may pave the way for more powerful, reliable, and practical quantum computing solutions capable of addressing complex computational tasks across various fields of science and technology.

Some embodiments disclosed herein may address one or more of the challenges of other quantum computing systems. For example, one or more embodiments herein may overcome one or more challenges by using a dual-helix quantum encoding architecture. Such an architecture may provide one or more of multidimensional information processing, parallel computation speed, enhanced storage efficiency, optimized error correction, or scalability for quantum computing tasks associated with AI. For example, quantum encoding may be expanded to include a spatial location of quantum nodes for higher computational density. Parallel computation speed may be improved through the dual-helix structure enabling simultaneous qubit processing across multiple helical chains, increasing quantum throughput. The architecture may support advanced quantum error correction techniques, reducing decoherence effects while maintaining high-fidelity quantum gates.

### OVERVIEW OF DUAL-HELIX QUANTUM ARCHITECTURE

In general, a quantum computing architecture as used in the embodiments described herein may include a plurality of quantum nodes arranged along two intertwined helices. The intertwined helices may extend along a longitudinal axis and may be offset angularly from one another. Each helix may include multiple quantum nodes positioned at different angular locations along the helix. An example dual-helix architecture is provided with respect to FIG. 2.

The dual-helix architecture provides a spatial organization in which quantum nodes have well-defined adjacency relationships along a helix and between helices. Quantum nodes on one helix may be coupled to corresponding or nearby nodes on the other helix using inter-helix connections, which may be referred to as rungs. These rungs may enable quantum communication, entanglement, or state transfer between the helices.

The dual-helix architecture and associated system are described with respect to FIGS. 1A, 1B, 2, and 3. This dual-helix architecture is one example of a spatially organized quantum computing system. Other spatial arrangements may also be used, and the disclosed techniques are not limited to any particular physical geometry unless expressly stated in the claims.

FIG. 1A illustrates an example quantum computing system 100 (hereinafter “system 100”) that includes such a dual-helix quantum encoding architecture, arranged in accordance with at least one embodiment herein. In particular, the system 100 includes a dual-helix quantum encoding structure 102 (hereinafter “dual-helix structure 102”), a multidimensional modulation controller 104 (hereinafter “controller 104”), and an error correction module 106. The system 100 may further include a central control module 108, a task scheduler 110, a photon system 112, one or more sensors 114 (hereinafter generically “sensors 114” or “sensor 114”), one or more quantum processing units (QPUs) 116, one or more memory modules 118, one or more real-time feedback loops 120, a classical computing interface 122, one or more waveguides and/or dynamic couplers 124, and an entanglement and cross-talk management module 126 (hereinafter “entanglement module 126”).

In general, the dual-helix structure 102 may include a first helix chain 102A and a second helix chain 102B. Each of the first helix chain 102A and the second helix chain 102B may include at least one of high-transparency quartz, fused silica, silicon nitride (SiN), lithium niobate (LiNbO₃), or other suitable material(s). The controller 104 may be configured to modulate quantum information in the first and second helix chains 102A, 102B using one or more of frequency modulation, phase modulation, and amplitude modulation. The dual-helix structure 102 may be configured to perform parallel quantum operations within the first helix chain 102A and the second helix chain 102B, e.g., under the direction or control of one or more of the central control module 108 or the task scheduler 110. The error correction module 106 may be configured to implement error correction within the first and second helix chains 102A, 102B using frequency modulation, phase modulation, and amplitude modulation provided through the controller 104.

The helix chains 102A, 102B may operate in parallel, each processing different quantum tasks simultaneously. The architecture of the system 100 may dynamically assign tasks to different helix chains 102A, 102B based on the complexity of the computations.

The system 100 may monitor, e.g., constantly or continuously, the modulated dimensions of frequency, phase, and amplitude of the helix chains 102A, 102B. For example, the sensors 114 may monitor the modulated dimensions of each of the first and second helix chains 102A, 102B. If one modulated dimension experiences an error (e.g., a phase drift), the system 100 may detect the error through real-time monitoring, e.g., by the sensors 114, and correct the error using the unaffected dimensions, e.g., using the error correction module 106, to restore an intended quantum state and/or maintain quantum state coherence.

The controller 104 may modulate the frequency, phase, and/or amplitude of each helix chain 102A, 102B in real-time. The controller 104 may ensure that each helix chain 102A, 102B operates at an optimal modulation level to prevent overlap or signal degradation. For example, the controller 104 may be configured to modulate, respectively, the phase, the frequency, and the amplitude of the dual-helix structure 102 of FIG. 1A. The controller 104 modulating the phase, frequency, and/or amplitude of the dual-helix structure 102 may include the controller 104 modulating the properties of individual photons that are processed at the various nodes of the dual-helix structure 102, rather than modifying structural properties of the dual-helix structure 102 itself.

Alternatively or additionally, a phase coupling mechanism may be implemented using the controller 104, together with one or more sensors 114, and/or the error correction module 106. The phase coupling mechanism may ensure phase synchronization between the helix chains 102A, 102B to reduce computational errors caused by phase misalignment. The phase coupling mechanism may detect phase drifts (e.g., using a phase sensor of the sensors 114) and correct misalignment by adjusting the phase of the affected helix chain 102A, 102B via the error correction module 106 and/or the controller 104.

In an example implementation, the classical computing interface 122 of FIG. 1A may be configured to receive classical data input. The classical computing interface 122 may be configured to convert the classical data input into quantum information suitable for processing by the dual-helix structure 102 and/or any of the QPUs 116. The classical computing interface 122 may be configured to transmit the quantum information to the controller 104 for modulation and processing in the first and second helix chains 102A, 102B.

The dual-helix quantum encoding architecture embodied in the system 100 of FIG. 1 may serve as a foundation for quantum state preparation, transfer, and processing, including embodiments that support routing of quantum information between subsystems. The system 100 may support encoding and transmission functionalities as well as quantum processing and memory/storage integration.

The system 100 may include or support quantum gates and circuits for performing operations on quantum states associated with qubits stored within the helix chains 102A, 102B, examples of which are described with respect to FIG. 1B and which may be incorporated into the dual-helix structure 102. Processing may occur at designated quantum nodes along each helix chain 102A, 102B, where modulation of frequency, phase, and amplitude, e.g., using the controller 104, may enable operations such as quantum logic gates (e.g., CNOT, Hadamard).

The parallel nature of the helix chains 102A, 102B may allow for concurrent quantum computations. The task scheduler 110 may dynamically assign tasks across the helix chains 102A, 102B to optimize, or at least improve, computational throughput. Nodes within the dual-helix structure 102 may act as quantum memory units, storing quantum states encoded via frequency, phase, and amplitude modulation. Alternately or additionally, the nodes within the dual-helix structure 102 may act as quantum processing elements that store and manipulate quantum states for computational operations in quantum computing applications.

The dual-helix quantum encoding architecture depicted in FIG. 1A may be combined with conventional computing systems to create a hybrid quantum-classical system. For example, the classical computing interface 122 may receive classical data inputs and convert them into quantum-encoded information for processing and transmit quantum computation results back as classical data outputs.

FIG. 1B illustrates an example implementation of the QPU 116 of FIG. 1A, arranged in accordance with at least one embodiment herein. As illustrated, the QPU 116 of FIG. 1B may include one or more of a readout subsystem module 128 (hereinafter “readout module 128”), a spatial data decoder 130, one or more polarization analyzers 132, one or more mode sorters 134, one or more interferometers 136, one or more quantum error correction protocols 138, a subsequent processing module 140, one or more single-qubit operations 142, one or more multi-qubit operations 144, a parallel processing dual-helix 146, and a feedback and intermediate data storage 148. The single-qubit operations 142 may include, for example, a Hadamard gate or other suitable single-qubit operations. The multi-qubit operations 144 may include, for example, a controlled NOT gate (C-NOT), a Toffoli gate (or controlled-CNOT or CCNOT gate), or other suitable multi-qubit operations. The parallel processing dual-helix 146 may be a subset or functional implementation of the dual helix structure 102 in FIG. 1A. The parallel processing dual-helix 146 may be optimized for use within a single QPU 116 (whereas the dual helix structure 102 may operate at the system level). The dual helix structure 102 may be a core component of the overall system 100 and may be integrated into one or more QPUs (116). However, the dual helix structure 102 may have broader functionality beyond a single QPU, supporting multiple QPUs and system wide parallel operations. Individual QPUs (116) may contain or include a localized implementation of a dual helix structure, referred to as the parallel processing dual-helix 146 herein. The feedback and intermediate data storage 148 may output data that may be, e.g., sent back to the dual-helix structure 102 of FIG. 1A at block 150 and/or transmitted to one or more other QPUs at block 152.

The waveguides and dynamic couplers 124 are depicted in FIG. 1A as being external to the dual-helix structure 102. In other embodiments, one or more of the waveguides and/or dynamic couplers 124 may be integrated directly into and/or embedded within the dual-helix structure 102, facilitating internal routing of encoded photons between processing nodes.

Referring to FIGS. 1A-1B, each QPU 116 includes a subsystem, such as the readout subsystem module 128, to detect and decode photons. The readout subsystem module 128 may include the spatial data decoder 130, the polarization analyzer 132, the mode sorter 134, and/or the interferometer 136. The readout subsystem module 128 may detect the incoming photons (received from the dual helix structure 102 via the waveguides and dynamic couplers 124) and extract quantum states using, e.g., the polarization analyzer 132 to detect polarization of each photon, the mode sorter 134 to detect OAM of each photon, and/or the interferometer 136 to detect the phase of each photon. The extracted quantum states may be mapped to qubits in the QPU 116 for subsequent processing.

The quantum error correction protocols 138 may be applied to ensure data integrity during transmission and decoding. The quantum error correction protocols 138 may include surface codes, Shor codes, or other suitable quantum error detection and/or correction protocols. The quantum error correction protocols 138 may be part of and/or implemented by the error correction module 106 of FIG. 1A. The quantum error correction protocols 138 may be an internal component or implementation of the broader error correction module 106. The QPU 116 may execute the quantum error correction protocols 138 as part of its quantum processing.

The subsequent processing module 140 may include the single-qubit operations 142, the multi-qubit operations 144, and/or the parallel processing dual-helix 146. The QPU 116 may perform single-qubit operations 142 (e.g., X, Z, Hadamard gates) to manipulate individual qubits based on a given computation task. The QPU 116 may also execute multi-qubit operations 144.

Processed quantum states generated by the subsequent processing module via the single-qubit operations 142, the multi-qubit operations 144, and/or the parallel processing dual-helix 146 may be sent back to the dual-helix structure 102 of FIG. 1A for storage or further routing, as indicated at block 150, and/or transmitted to other QPUs 116 for additional computation, as indicated at block 152. Quantum memory modules, such as the memory module 118 of FIG. 1A, may store intermediate results or checkpointed states for multi-step computations.

Referring to FIG. 1A, the central control module 108 may coordinate data flow between the dual-helix structure 102 and the QPUs 116, and may ensure that operations are synchronized. The central control module 108 may dynamically allocate QPU resources based on task priority and node availability. The real-time feedback loops 120 may monitor photon fidelity, gate execution, and/or routing efficiency. Adjustments may be made dynamically, e.g., as part of the real-time feedback loops 120, to minimize losses and optimize performance.

Further description of the system 100 is found in U.S. patent application Ser. No. 19/083,366, filed on Mar. 18, 2025, entitled Dual-Helix Quantum Encoding Architecture And Multidimensional Quantum Computing System and U.S. patent application Ser. No. 19/208,461, filed on May 14, 2025, entitled Quantum Secure Communication Protocol And Device Based On Double-Helix Structure Composite Multi-Layer Encoding, the entire disclosures of which are incorporated herein by reference in their entireties.

FIG. 2 is a view of an example dual-helix quantum architecture showing interleaved A-helix chain and B-helix chain quantum nodes, arranged in accordance with at least one embodiment herein. The layout includes A-helix chain quantum nodes, labeled A0 through A31 and denoted by crosses (A0-A31), and B-helix chain quantum nodes, labeled B0 through B31 and denoted by open squares (B0-B31), each arranged along two interleaved helical paths. The A-helix chain and B-helix chain helices are offset by approximately 180 degrees at each Z level, resulting in paired A and B quantum nodes at the same vertical (Z) position in 3D space. This arrangement visually represents the logical adjacency and pairing of A and B quantum nodes at each height, as well as the nearest-neighbor connections along each helix.

The phrase “dual-helix logical node layout,” as used in this disclosure, refers to an arrangement of quantum nodes in 3D space in which two interleaved chains of quantum nodes follow helical paths, with each chain offset from the other by a fixed angular phase. The purpose of the dual-helix logical quantum node layout is to provide a logical framework for organizing quantum nodes such that both local and cross-chain adjacency are preserved, thereby supporting efficient routing and scalable quantum processor architectures. The term “logical” is used herein to clarify that the node organization defined in 3D space is distinct from the physical layout of node cores described in two-dimensional (2D) space for various embodiments described herein.

The mapping relationship between the dual-helix logical node layout 200 and the planar mapping coordinate frame 300 is established by projecting each node from its three-dimensional position onto the two-dimensional plane in a manner that preserves adjacency and logical pairing. In some embodiments, the dual-helix logical node layout 200 provides the starting three-dimensional coordinates for each A-helix chain and B-helix chain node, and the projection process defines the layout in X′ and Y′ such that, with only a few exceptions, similarly-indexed nodes that are proximate to each other in the 3D layout retain relative spatial proximity in the 2D layout.

The parametric equations for the 3D helix may be expressed as x(theta)=r*cos(theta), y(theta)=r*sin(theta), and z(theta)=(p*theta)/(2*pi), where r is the helix radius, p is the z-direction pitch, and theta is the angular coordinate. The planar projection may use mapping equations such as X′=z and Y′=(r*theta) mod(2*pi*r), with the modulo function in the Y′ mapping ensuring that nodes from different turns of the helix are distributed within a fixed vertical range in the planar layout. The preservation of logical connectivity and adjacency in the projected layout is achieved by maintaining the adjacency of nearest-neighbor quantum nodes along each chain (A-helix chain and B-helix chain), as well as the vertical alignment of cross-chain node pairs (A_i and B_i).

FIG. 3 is view illustrating an example spiral-unwrapped placement of quantum nodes on the A-helix chain and B-helix chain and links 301 and 302 between the quantum nodes, arranged in accordance with at least one embodiment herein. In FIG. 3, the links 301 couple quantum nodes which are nearest neighbors within the same slanted column. The links 302 provide connections between nodes in adjacent slanted columns that are substantially aligned in the vertical (Y′) direction. For instance, the links 301 may be established between nearest-neighbor nodes such as B5 and B6 or between A19 and A20, while the links 302 may provide cross-chain connections between nodes such as A1 and B1 or B20 and A20, where the nodes are located in adjacent slanted columns and have the same index number.

In some embodiments, the links 301 and the links 302 may be configured to provide optical signal routing between quantum nodes. The links 301 and the links 302 may include in-plane waveguide paths and vertical optical interconnects for cross-layer communication. Examples of such photonic routing layers may include silicon nitride waveguide layers, silicon dioxide cladding layers, or other dielectric waveguide structures configured for low-loss optical transmission. Other links may be made between other of the quantum nodes than those illustrated. For example, links may be formed between the A1 and A3. In these and other embodiments, links may be formed so that any two nodes may be reached in O(log N) hops by utilizing both intra-strand neighbor links and inter-strand links, thereby achieving logarithmic-diameter connectivity across the entire quantum processing architecture.

### QUANTUM NODE MODEL AND SPATIAL ORGANIZATION

In some embodiments, each quantum node may be associated with a spatial coordinate derived from its position along a helix in a dual-helix structure, such as illustrated in FIGS. 2 and 3. The spatial coordinate may include an angular position θ and, optionally, corresponding Cartesian coordinates (x, y, z). In one embodiment, the angular position θ may be determined according to θi=i·Δθ, where i represents a node index and Δθ represents an angular increment between successive nodes. The Cartesian coordinates may be derived from the angular position according to xi=r·cos(θi), yi=r·sin(θi), and zi=(h/2π)·θi, where r represents a helix radius and h represents a helix pitch. The spatial coordinate may provide a deterministic mapping between node index and physical position within a three-dimensional helical structure.

The spatial coordinate may be used for addressing, routing, scheduling, or organizing quantum operations. In one embodiment, the spatial coordinate may serve as an addressable quantum register that may be manipulated by quantum gates. The spatial coordinate may facilitate efficient routing by allowing quantum operations to be scheduled based on physical proximity of nodes, thereby reducing communication overhead and circuit depth. Alternately or additionally, such spatial relationships may be used to constrain or prioritize quantum operations, reduce routing overhead, or organize execution.

In some embodiments, a dual-helix structure and the associated quantum nodes on the helix structure may be divided into segments. Each segment may comprise a contiguous group of quantum nodes along a helix chain. The segment boundaries may be defined by angular positions along the helical structure.

The selection of segments, e.g., the segment boundaries, may be based on the computational requirements of a quantum artificial intelligence task. The number of quantum nodes in each segment may be determined by the angular span of the segment. For example, a segment spanning an angular range of Δθ may contain Nsegment quantum nodes, where Nsegment may be calculated as Δθ divided by the angular step between adjacent nodes. The angular step between adjacent nodes may be denoted as δθ. The relationship may be expressed as Nsegment=Δθ/δθ. The angular span Δθ of each segment may be selected based on the coherence time of the quantum nodes, the complexity of the quantum operations to be performed within the segment, and the desired level of parallelism across segments.

The number of quantum nodes in each segment may range from a minimum of two nodes to a maximum equal to the total number of nodes in a complete helical turn. A complete helical turn may correspond to an angular span of 2π radians. The number of nodes per complete turn may be denoted as Nturn. The maximum number of nodes in a segment may therefore be Nturn. The minimum number of nodes in a segment may be two nodes, which may enable the simplest form of quantum entanglement operations between adjacent nodes within the segment.

The selection of segment boundaries may be performed algorithmically based on the structure of a quantum circuit to be executed. For example, a quantum circuit may comprise multiple layers of quantum gates. Each layer may correspond to a set of quantum operations that may be executed in parallel. The segment boundaries may be aligned with natural boundaries in the quantum circuit structure. For example, segment boundaries may be placed between layers of quantum gates that require synchronization or aggregation of results. The segment boundaries may also be placed to minimize the number of quantum operations that span across segment boundaries, thereby reducing the communication overhead between segments.

The segments may be of equal size, with each segment containing the same number of quantum nodes. Alternatively, the segments may be of varying sizes, with different segments containing different numbers of quantum nodes. The size of each segment may be determined based on the computational load assigned to that segment. Segments assigned more computationally intensive tasks may contain more quantum nodes. Segments assigned less computationally intensive tasks may contain fewer quantum nodes. This variable segment sizing may enable load balancing across a dual-helix structure.

The segments may be contiguous along the helix chain, with each segment immediately following the previous segment in the angular coordinate. Alternatively, the segments may be non-contiguous, with gaps between segments. The gaps between segments may contain quantum nodes that are not assigned to any segment during a particular computational phase. These unassigned nodes may be reserved for error correction operations, calibration operations, or future computational tasks.

The segments may be defined on a single helix chain, such as the first helix chain 102A or the second helix chain 102B. Alternatively, the segments may span across both helix chains, with each segment containing quantum nodes from both the first helix chain 102A and the second helix chain 102B. Segments that span across both helix chains may utilize the rung couplers to enable quantum operations between nodes on different helix chains within the same segment.

In some embodiments, the segment boundaries may enable parallel execution of quantum operations across multiple segments. In these and other embodiments, different segments may be prepared for different computational subtasks.

Note that while the dual-helix structure may be divided into segments in some embodiments, other embodiments may not have the dual-helix structure divided into segments.

### QUANTUM STATE ENCODING AND POSITIONAL MODES

In some embodiments, quantum states processed by the architecture may include one or more encoding dimensions. These dimensions may include, by way of example and not limitation, amplitude, phase, polarization, frequency, orbital angular momentum, time bin, spatial mode, or other degrees of freedom. Each encoding dimension may provide an independent channel for representing information within the quantum state. The combination of multiple encoding dimensions may enable high-dimensional quantum state representations that may support complex computational tasks.

In some embodiments, the spatial coordinate of a quantum node may serve as an additional encoding dimension. The spatial coordinate may be derived from the angular position θ of the quantum node along the helix. The spatial coordinate may be represented as a positional mode within the quantum state. The positional mode may be expressed as |θ>, where θ corresponds to the angular position of the quantum node. The positional mode may be treated as a quantum register that may be manipulated by quantum operations. The positional mode may enable position-dependent quantum operations that may exploit the geometric structure of the double-helix architecture.

Note that the use of positional modes is optional and may vary depending on the quantum algorithm or workload being executed.

As an example of positional modes in the dual-helix structure 102, each quantum node may store a quantum state that may include orbital angular momentum (OAM) modes, polarization states, phase values, and/or spatial position information. The OAM modes may be initialized to specific angular momentum values l. The polarization states may be initialized to horizontal, vertical, left-circular, or right-circular polarization. The phase values may be initialized to specific phase angles φ. The spatial position information may be encoded in a positional mode corresponding to the node's angular coordinate θ. For example, each quantum node positioned along the two intertwined helices may be assigned a deterministic spatial coordinate (xi, yi, zi) derived from the angular position θi according to the parametric equations xi=r·cos(θi), yi=r·sin(θi), and zi=(h/2π)·θi, where r denotes the helix radius, h denotes the pitch, and θi=i·Δθ represents the angular coordinate of node i. The spatial coordinate θi may function simultaneously as a logical register within a quantum state representation |l, p, φ; θ> and as a physical address identifying the geometric location of the node within the three-dimensional helical structure.

In some embodiments, the dual nature of the spatial coordinate may enable quantum circuits to perform position-dependent operations by applying phase gates proportional to θi, selecting neighboring nodes based on their angular proximity, or routing quantum information along paths determined by the helical geometry. The deterministic mapping between node index i and spatial position θi may provide a consistent addressing scheme that may be exploited by compilation algorithms to minimize routing overhead and by runtime schedulers to distribute computational tasks across spatially localized segments of the helix.

In some embodiments, the spatial coordinate may be encoded into the quantum state through positional phase tagging, wherein a unitary operator Upos(k)=exp(ikθi) may be applied to each node to embed the angular position as a phase factor. The resulting state e\hat{ }(ikθi)|l, p, φ; θ> may carry positional information that may be accessed through interference-based operations or Fourier transforms performed across the θ-register. The positional phase tagging may enable circuits to implement convolution-like operations by coupling nodes at positions θ and θ±kΔθ, where the phase relationship between coupled nodes may encode spatial frequency components analogous to classical convolutional kernels.

In some embodiments, the positional mode may allow for restriction of gate connections to physically adjacent or geometrically proximate nodes, thereby reducing the need for long-range SWAP operations that typically introduce errors and increase circuit depth in planar quantum architectures.

In some embodiments, the positional mode may allow for segment-scoped parameter tying mechanism that may enforce shared trainable parameters across all nodes in a segment, such that gradient updates computed at individual nodes may be averaged to produce a single parameter update applied uniformly throughout the segment. The positional mode may thus serve as both a quantum degree of freedom that may be manipulated by gates and measurements, and as a classical index that may be used by compilers and schedulers to organize quantum operations according to the physical topology of the double-helix architecture.

### EXECUTION, SCHEDULING, AND PARALLELISM FRAMEWORK

In some embodiments, the quantum computing architecture as discussed in this disclosure may be organized into layers such that no quantum node participates in more than one operation within a given layer. As a result, each layer may represent a set of quantum operations that may be executed in parallel without conflict, where conflict may be defined as two or more operations attempting to act on the same quantum node simultaneously. The organization into layers may enable efficient parallel execution of quantum operations while maintaining the integrity of quantum states at each node. The layer structure may be determined by analyzing the connectivity graph of the quantum computing architecture and identifying sets of operations that may be performed concurrently without violating the constraint that each node participates in at most one operation per sublayer.

The architecture may support multiple layers within a single layer of quantum computation, referred to as sublayers, where each sublayer may correspond to a distinct set of non-conflicting operations. The number of sublayers required for a given layer of quantum computation may depend on the connectivity pattern of the operations and the physical topology of the quantum nodes along the intertwined helices. Operations within a sublayer may be executed simultaneously across different quantum nodes, thereby reducing the overall execution time for the layer.

In some embodiments, the layer organization may be particularly advantageous in architectures where quantum nodes are spatially distributed along helical structures, as the geometric arrangement may naturally suggest groupings of operations that may be performed in parallel without interference. Note that the scheduling mechanisms described herein are provided as illustrative examples of how quantum operations may be coordinated on a spatially organized architecture. The architecture does not require any particular scheduling strategy, and different scheduling approaches may be used depending on the algorithm, workload, or hardware implementation.

### PARAMETER HANDLING AND OPTIMIZATION SUPPORT

Furthermore, the quantum computing architecture described herein may support various approaches to parameter management during quantum operations. Parameters in quantum circuits may include rotation angles, phase values, coupling strengths, and other adjustable quantities that influence the behavior of quantum gates and operations. The manner in which parameters are handled may affect the efficiency, accuracy, and scalability of quantum computations performed on the architecture.

In some embodiments, parameters may be managed at different levels of granularity within the quantum computing architecture. At a local level, individual quantum nodes may maintain parameter values that govern the behavior of quantum gates applied at those nodes. At a segment level, groups of quantum nodes organized into segments may share parameter values, thereby reducing the total number of independent parameters that must be managed and optimized. At a global level, parameter values may be coordinated across multiple segments or across the entire quantum computing architecture to maintain consistency and coherence in quantum operations. The hierarchical organization of parameter management may enable efficient scaling of quantum computations while maintaining control over the behavior of individual quantum operations. Different levels of parameter management may be employed depending on the specific requirements of the quantum algorithm being executed, the characteristics of the quantum hardware, and the desired trade-offs between computational efficiency and operational flexibility.

In some embodiments, parameter aggregation may be performed classically, quantum-mechanically, or using hybrid approaches. Note that the dual-helix architecture is not limited to any particular optimization algorithm or parameter update rule. Gradient-based methods, reinforcement learning techniques, heuristic optimizers, or other optimization approaches may be used depending on the application.

The parameter handling mechanisms described herein are intended to illustrate architectural support for parameterized quantum algorithms and do not define a specific optimization method unless expressly claimed.

### ILLUSTRATIVE AI WORKFLOWS SUPPORTED BY THE ARCHITECTURE

By way of example only, the disclosed architecture may support a variety of artificial intelligence workflows, including but not limited to:
Quantum neural network training and inference
Variational quantum optimization for machine learning or combinatorial problems
Similarity-based inference or data placement
Hybrid quantum-classical execution pipelines

These workflows are provided as non-limiting examples. The architecture may support other quantum algorithms and workloads beyond artificial intelligence applications.

FIG. 4 illustrates an example process flow 400 for quantum computing using a dual-helix quantum architecture, arranged in accordance with at least one embodiment herein. The process flow 400 may be executed by the system 100 of FIG. 1A, utilizing the dual-helix structure 102 and associated components. The process flow 400 may enable quantum neural network training, variational quantum optimization, or other quantum artificial intelligence tasks by leveraging the spatial topology and multi-dimensional encoding capabilities of a dual-helix architecture.

The process flow 400 may include an initialization/design phase 402, an orchestration phase 406, an execution phase 408, a parameter adjustment phase 410, an error correction phase 412, a convergence/evaluation phase 414, and an inference and output phase 416. Each phase may be performed sequentially or with partial overlap depending on the specific quantum computing task and hardware configuration.

The process flow 400 of FIG. 4 may provide a comprehensive framework for executing quantum artificial intelligence workloads on the dual-helix quantum architecture described herein. The process flow 400 may enable end-to-end processing of quantum neural network training, variational quantum optimization, and quantum machine learning tasks by leveraging the spatial topology and multi-dimensional encoding capabilities inherent to the double-helix structure.

The initialization/design phase 402 may include state preparation of quantum nodes positioned along the two intertwined helices of the dual-helix structure 102 for quantum computing operations. State preparation may involve configuring quantum nodes to establish initial quantum states and setting up the quantum system architecture before data processing operations. For example, the state preparation process may include establishing quantum connections between nodes on different helices through rung couplers and configuring segment boundaries for parallel execution of quantum operations across multiple regions of the dual-helix structure 102.

In some embodiments, the inherent high connectivity of the double helix may be used to generate multi-path quantum superposition states that extend the search coverage of the quantum approximate optimization algorithm. In these and other embodiments, the multi-path quantum superposition states may be generated by applying entangling operations between quantum nodes positioned at different spatial coordinates along the intertwined helices. Each quantum node may store a quantum state that includes a positional mode corresponding to the spatial coordinate of that node. The entangling gates may create superposition states that span multiple quantum nodes simultaneously. The entangling gates may be applied between quantum nodes that are physically adjacent along a single helix chain. Alternatively or additionally, the entangling gates may be applied between quantum nodes that are positioned on different helix chains but at substantially the same angular position along the intertwined helices.

The multi-path quantum superposition states may enable quantum interference effects that enhance computational capacity. The quantum state at a first quantum node may be entangled with the quantum state at a second quantum node through application of a two-qubit gate operation. The two-qubit gate operation may be a controlled-NOT gate, a controlled-phase gate, or another suitable entangling gate. The entangling gate may create a superposition state in which the quantum states of the first and second quantum nodes are correlated. The correlation may persist even when the quantum nodes are separated by multiple angular positions along the helix chains. The multi-path quantum superposition states may allow quantum information to propagate through multiple pathways simultaneously. Each pathway may correspond to a different sequence of quantum nodes along the helix chains.

The generation of multi-path quantum superposition states may involve selecting pairs of quantum nodes based on their positional modes. The selection may prioritize quantum node pairs that are separated by a predetermined angular distance along the helix chains. The predetermined angular distance may be chosen to optimize circuit depth while maintaining sufficient connectivity between quantum nodes. The entangling gates may be organized into sublayers such that no quantum node participates in more than one entangling gate per sublayer. This organization may enable parallel execution of multiple entangling gates within each sublayer. The parallel execution may reduce the total circuit depth required to generate the multi-path quantum superposition states. The circuit depth may be further reduced by utilizing rung connections between the first helix chain and the second helix chain.

For Quantum Neural Network (QNN) tasks, the initialization/design phase 402 may prepare qubits in the |+>\hat{ }⊗n state. The |+>\hat{ }⊗n state may represent a tensor product of n qubits, where each qubit may be initialized to the superposition state |+>=(|0>+|1>)/√2. The preparation of the |+>\hat{ }⊗n state may be accomplished by first preparing the |0>\hat{ }⊗n state and then applying Hadamard gates to each qubit. The Hadamard gate may transform the computational basis state |0> into an equal superposition of |0> and |1>. The |+>\hat{ }⊗n state may provide a maximally mixed initial state that may be suitable for quantum machine learning applications. The superposition property of the |+>\hat{ }⊗n state may enable quantum neural networks to explore multiple computational paths simultaneously.

For Quantum Neural Network (QNN) tasks, inference operations on the quantum computing architecture may employ entangled states representing possible reasoning paths. The selection and preparation of these entangled states may be performed to provide coverage of the solution space while managing the distribution of quantum amplitudes across the computational basis states. The quantum computing architecture may support inference workloads by distributing entangled states across quantum nodes positioned along the two intertwined helices.

During inference, quantum gates may be executed between quantum nodes to propagate information through the network. The execution of quantum gates may create entanglement between quantum nodes, allowing quantum information to be distributed across multiple nodes simultaneously. The entangled states may represent multiple reasoning paths that may be evaluated in parallel. The quantum computing architecture may support the simultaneous evaluation of multiple inference paths through the use of quantum superposition and entanglement.

The initialization of entangled states for inference operations on the quantum computing architecture may be performed according to an algorithm that constructs an inference graph representing logical relationships among computational elements. The inference graph may include nodes corresponding to variables or data points and edges representing dependencies or correlations between the nodes. The algorithm may analyze the structure of the inference graph to determine optimal initial quantum states that encode the inference problem in a form suitable for quantum processing on the dual-helix architecture.

The algorithm may begin by receiving a specification of the inference task, which may include a set of input variables, a set of output variables, and a set of conditional relationships or constraints that define the inference problem. The algorithm may construct an adjacency matrix representation of the inference graph, where each entry in the matrix may indicate the presence or strength of a connection between two nodes in the graph. The adjacency matrix may be analyzed using spectral decomposition techniques to identify dominant eigenvectors that capture the primary structural features of the inference graph. The eigenvectors corresponding to the largest eigenvalues may represent the most significant patterns of correlation or dependency within the inference problem. The algorithm may select a predetermined number of these dominant eigenvectors based on the desired coverage of the solution space and the available quantum resources.

After selecting a predetermined number of dominant eigenvectors from the spectral decomposition of the inference graph adjacency matrix, the algorithm may proceed to construct initial quantum states that encode the structural features captured by those eigenvectors. Each selected eigenvector may represent a distinct pattern of correlation or dependency within the inference problem. The algorithm may normalize each eigenvector to ensure that the resulting quantum state may be prepared with unit probability. The normalized eigenvector components may be mapped to amplitude coefficients of a quantum superposition state. For a given eigenvector vk with components v{k, i} corresponding to inference variables indexed by i, the algorithm may prepare a quantum state of the form |ψk>=Σi v{k, i}|i>, where the summation may extend over all variables in the inference graph. The preparation of such states may be performed using standard quantum state preparation techniques that may include sequences of rotation gates and controlled operations applied to quantum nodes positioned along the two intertwined helices of the quantum computing architecture.

The algorithm may assign each prepared quantum state |ψk> to one or more quantum nodes within the dual-helix architecture based on the spatial coordinates of those nodes and the logical structure of the inference problem. Quantum nodes that may be assigned states derived from the same eigenvector may be grouped into segments of the intertwined helices to facilitate parallel processing and efficient entanglement generation. The algorithm may apply entangling operations between quantum nodes that may store states derived from different eigenvectors to create superposition states that may span multiple reasoning paths simultaneously. These entangling operations may be implemented using two-qubit gates that may extend between quantum nodes on the same helix or between quantum nodes on different helices via rung connections. The resulting entangled states may enable the quantum computing architecture to explore multiple inference paths in parallel during the execution of quantum circuits designed for inference operations. The algorithm may further optimize the assignment of eigenvector-derived states to quantum nodes by considering the connectivity structure of the dual-helix architecture and the communication requirements of the inference algorithm to minimize circuit depth and reduce the number of long-range quantum gates required during inference execution.

The initialization/design phase 402 may involve specific hardware components of the dual-helix structure 102. The multidimensional modulation controller 104 may generate control signals for state preparation operations. The control signals may include voltage pulses for superconducting qubits, laser pulses for photonic qubits, or radio-frequency pulses for ion trap qubits. The central control module 108 may coordinate the timing of initialization operations across multiple quantum nodes. The task scheduler 110 may determine which quantum nodes may be initialized for particular computational tasks. The sensors 114 may monitor the fidelity of prepared quantum states. The error correction module 106 may detect and correct initialization errors that may occur during state preparation.

The initialization/design phase 402 may prepare quantum nodes on both the first helix chain 102A and the second helix chain 102B. The quantum nodes on the first helix chain 102A may be initialized to the same quantum state as quantum nodes on the second helix chain 102B. Alternatively, the quantum nodes on the first helix chain 102A may be initialized to a different quantum state than quantum nodes on the second helix chain 102B. The initialization of quantum nodes on different helix chains may enable parallel processing of different computational tasks. The rung couplers may establish quantum connections between corresponding nodes on the first helix chain 102A and the second helix chain 102B after initialization.

In some embodiments, the initialization/design phase 402 may include segmentation of the quantum nodes or the multi-dimensional encoding.

In some embodiments, the initialization/design phase 402 may include mapping input datasets to quantum nodes. The mapping process may utilize the deterministic spatial coordinates of quantum nodes along the helical structure to assign computational elements to specific quantum nodes based on the spatial coordinate of that node along the helical structure. The assignment process may determine which computational element occupies which quantum node position.

In some embodiments, the initialization/design phase 402 may include other operations. For example, the initialization/design phase 402 may include calibration of quantum gates and measurement apparatus, preparation of error correction infrastructure, and loading of pre-compiled quantum circuits or circuit templates. Calibration may involve characterization of gate fidelities, measurement of coherence times, and determination of optimal control parameters, with calibration data stored in lookup tables for use during circuit execution. Error correction infrastructure may include stabilizer measurement circuits, syndrome extraction logic, and error decoding algorithms configured based on the helical structure geometry. Pre-compiled circuits representing standard operations such as Fourier-like transforms or neural network layer implementations may be loaded from a circuit library to reduce compilation time.

The orchestration phase 406 may follow the initialization/design phase 402. In some embodiments, the orchestration phase 406 includes compilation and scheduling operations that transform the initialized quantum system into an executable configuration for a the dual-helix architecture. Compilation may translate a logical quantum circuits into physical gate sequences that exploit the geometric properties of a helical node topology. Compilation includes, for example, mapping logical qubits to physical quantum nodes positioned along two intertwined helices based on spatial coordinates and connectivity patterns established during initialization.

In some embodiments, the orchestration phase 406 may include a mapping algorithm for mapping layers of a network onto quantum nodes positioned along the two intertwined helices. The mapping algorithm may support, for example, feedforward networks, convolutional networks, recurrent networks, transformer-like networks, and combinations thereof. For convolutional architectures, the mapping may assign convolutional kernels to localized groups of quantum nodes, and kernel parameters may be shared across spatial positions using segment-scoped parameter tying. For recurrent architectures, the mapping may assign recurrent connections to rung links that connect nodes at different vertical positions along the helix to encode temporal dependencies using the spatial topology.

The mapping algorithm may optimize layer-to-node assignment based on connectivity requirements and resource constraints. For example, layers with higher inter-layer connectivity may be assigned to node groups that are connected by high-fidelity rung couplers, and layers with higher computational requirements may be assigned to segments of the helix with higher node availability and/or enhanced quantum processing capabilities. The optimization may balance competing objectives such as minimizing circuit depth, maximizing parallelism, and reducing communication overhead.

By way of example, the orchestration phase 406 may include a method for mapping layers of a quantum neural network (QNN) onto quantum nodes positioned along the two intertwined helices. The mapping method may assign each network layer of a plurality of network layers to a distinct set of quantum nodes such that adjacent network layers are assigned to sets of quantum nodes on different ones of the intertwined helices. Adjacent network layers may be layers that are consecutive in an ordered sequence of layers in the quantum neural network. The assignment of adjacent layers to different helices may enable efficient inter-layer communication through cross-strand rung connections while maintaining spatial locality within each layer.

The mapping method may begin by determining a number of quantum nodes required for a first network layer. The determination may be based on the width of the layer, which may correspond to the number of neurons or quantum processing elements required to represent the layer's computational capacity. The width of the layer may correspond to the number of neurons or quantum processing elements required to represent the layer's computational capacity. Each layer of a quantum neural network may be characterized by a width parameter that may determine how many quantum nodes are allocated to that layer within the helical structure. The width may be selected based on the dimensionality of the input data, the complexity of the transformations to be performed, or the desired representational capacity of the layer. For example, a first layer of a quantum neural network may have a width of sixteen neurons, which may correspond to sixteen quantum nodes positioned along a contiguous angular segment of the first helix chain. A second layer may have a width of thirty-two neurons, which may correspond to thirty-two quantum nodes positioned along a contiguous angular segment of the second helix chain. The width of each layer may be determined during the initialization phase based on the architecture of the quantum neural network being implemented. The assignment of layer width to physical nodes may ensure that each layer has sufficient quantum resources to perform its designated computational operations while maintaining spatial locality along the helical structure.

A first set of quantum nodes on a first helix of the intertwined helices may be selected, where the number of quantum nodes in the first set equals the determined number of quantum nodes for the first network layer. The first set of quantum nodes may comprise contiguous quantum nodes on the first helix, meaning the nodes may be positioned at consecutive angular positions along the helical structure without gaps in the angular coordinate sequence.

For a second network layer adjacent to the first network layer, the method may determine a number of quantum nodes required for the second network layer. A second set of quantum nodes on a second helix of the intertwined helices may be selected, where the number of quantum nodes in the second set equals the determined number of quantum nodes for the second network layer. The alternating assignment of consecutive layers may refer to a mapping strategy wherein successive layers of a quantum neural network are assigned to quantum nodes on different helices of the double-helix architecture. In one embodiment, odd-numbered layers may be assigned to nodes on a first helix chain while even-numbered layers may be assigned to nodes on a second helix chain. For example, Layer 1 may be mapped to a contiguous segment of nodes on helix chain A, Layer 2 may be mapped to a corresponding segment on helix chain B, Layer 3 may return to helix chain A, and Layer 4 may return to helix chain B. The alternating pattern may continue for all layers in the network. This alternating assignment may enable spatial pipelining, wherein forward propagation through Layer 1 on helix A may occur concurrently with forward propagation through Layer 2 on helix B. Cross-strand rung couplers may facilitate inter-layer communication between adjacent layers residing on opposite helices. The alternating assignment may reduce the need for long-range routing along a single helix, as each layer may communicate with its predecessor and successor via short rung connections rather than extended helical paths.

The alternating assignment may also support bidirectional data flow, wherein gradient information during backpropagation may travel downward through the same rung connections used for forward propagation. For example, during the execution phase 408, gradient information may travel downward through the same rung connections used for forward propagation. The rung couplers between nodes on the first helix chain 102A and the second helix chain 102B may operate bidirectionally, enabling both forward data flow and backward gradient flow within the same physical interconnect structure. For example, during forward propagation, a quantum state may be transmitted from a node on the first helix chain 102A to a corresponding node on the second helix chain 102B via a rung coupler. During backpropagation, gradient information computed at the node on the second helix chain 102B may be transmitted back to the node on the first helix chain 102A through the same rung coupler. The bidirectional operation may be achieved through time-multiplexed control signals that alternate the direction of quantum state transfer, or through simultaneous bidirectional channels implemented using distinct optical wavelengths or polarization states in photonic implementations. In superconducting implementations, the rung coupler may support bidirectional entanglement operations where forward and backward information flow may be encoded in different measurement bases or temporal windows. The reuse of the same physical rung connections for both forward and backward propagation may reduce the total number of required interconnects and may simplify the overall system architecture compared to architectures requiring separate forward and backward communication channels.

The alternating assignment of network layers may also balance computational load across both helix chains, preventing one chain from becoming a bottleneck. The alternating assignment may also enable redundancy, as logical qubits may be encoded across both chains to mitigate spatially correlated errors affecting a single chain. Furthermore, the mapping method may form quantum connections between different sets of quantum nodes on different ones of the intertwined helices. These quantum connections may be implemented through rung couplers that provide direct quantum communication channels between nodes on the first helix and nodes on the second helix. The rung connections may enable inter-layer data transfer with reduced circuit depth compared to routing schemes that require multiple intermediate nodes. In some embodiments, coupling strength κ_{ij} of rung interconnects may be adaptively adjusted to maintain target entanglement fidelity F_target according to κij (t+1)=κij (t)+λ(F_{target}−Fᵢⱼ(t)), where λ is a tuning coefficient. Measured fidelity F_{ij} is obtained through calibration pulses, and the phase-shifter voltage V_{ij} is updated proportionally to Δκ. Automatic tuning may compensate for thermal or optical drift during prolonged operation.

The orchestration phase 406 may further include resource allocation operations that distribute computational resources across the quantum computing architecture. The resource allocation operations may include assigning classical control resources to specific segments of the helical structure. The resource allocation operations may include allocating measurement apparatus to designated aggregator nodes. The resource allocation operations may include reserving quantum memory resources for intermediate state storage during multi-layer quantum neural network execution.

The execution phase 408 may follow the orchestration phase 406 and may involve the actual running of quantum circuits on the quantum computing architecture. The execution phase 408 may include applying quantum gates to quantum nodes, performing measurements, and collecting results according to the schedules and mappings established during the orchestration phase 406. The execution phase 408 may leverage the spatial topology of the double-helix structure to enable parallel execution of quantum operations across multiple segments while maintaining coherence and reducing routing overhead.

The parameters adjustment phase 410 may follow the execution phase 408 and may involve updating variational parameters that control the behavior of quantum gates and operations within the quantum computing architecture. The parameters adjustment phase 410 may enable iterative refinement of quantum circuit performance by modifying rotation angles, coupling strengths, phase offsets, and other adjustable quantities that influence quantum state evolution. The parameters adjustment phase 410 may be performed using gradient-based optimization methods, reinforcement learning techniques, or hybrid quantum-classical approaches that combine quantum measurement outcomes with classical computational resources.

In some embodiments, the gradients computed during the parameters adjustment phase 410 may be aggregated across multiple quantum nodes, segments, and/or measurement shots to reduce statistical noise and improve stability of parameter updates. The parameters adjustment phase 410 may employ adaptive learning rate schedules, momentum-based optimization, or second-order methods that adjust the magnitude and direction of parameter updates based on the history of previous gradient measurements and the curvature of the cost function landscape.

The error correction phase 412 may follow the parameter adjustment phase. The error correction phase 412 may implement quantum error correction and/or error mitigation procedures adapted to the double-helix quantum architecture. The error correction phase 412 may detect and correct errors that accumulate during quantum circuit execution in the execution phase 408. The error correction protocols may exploit the geometric properties of the double-helix structure to provide efficient syndrome extraction and error recovery. The error correction phase 412 may operate continuously or periodically during quantum computation to maintain logical qubit fidelity above threshold values required for fault-tolerant operation.

The convergence/evaluation phase 414 may follow the error correction phase 412. The convergence/evaluation phase 414 may determine whether the quantum computing system has reached a satisfactory solution state for the AI task being executed. The convergence/evaluation phase 414 may assess multiple metrics to evaluate whether further iterations of parameter updates and circuit executions are warranted or whether the optimization process may be terminated. In some embodiments, in response to further iterations of parameter updates and/or further circuit executions being warranted, the process flow 400 may return to orchestration phase 406. In response to no further iterations of parameter updates and/or no further circuit executions being warranted, the process flow 400 may proceed the inference and output phase 416.

The inference and output phase 416 may follow the convergence/evaluation phase 414. The inference and output phase 416 may generate final predictions or solutions from the trained quantum computing system. The inference and output phase 416 may process new input data through the optimized quantum circuit to produce actionable outputs for the AI task being executed.

The inference and output phase 416 may include loading new input data into the quantum computing architecture. The new input data may be distinct from the training data used during previous phases. The new input data may represent test samples, validation samples, or production data for which predictions or classifications are desired. The quantum computing architecture may encode the new input data using the same multi-dimensional encoding scheme applied during training. Each data element may be assigned to a quantum node positioned along the two intertwined helices based on the spatial coordinate θ derived from the helical geometry.

The inference and output phase 416 may include executing the quantum circuit with the optimized parameters obtained from the parameter adjustment phase 410. The optimized parameters may include rotation angles for single-qubit gates, coupling strengths for two-qubit gates, phase offsets for positional phase tagging operations, and other parameterized quantum operations. The quantum circuit may apply the same sequence of quantum gates used during training, but with the parameter values fixed at their optimized values rather than being updated iteratively. The quantum gates may transform the quantum states representing the new input data according to the learned mapping encoded in the optimized parameters.

The process flow 400 illustrated in FIG. 4 may represent one example embodiment of how quantum computing operations may be organized and executed on the dual-helix quantum architecture described herein. The particular sequence of phases shown in FIG. 4 may be adapted, modified, or reorganized depending on the specific quantum artificial intelligence workload, hardware configuration, or algorithmic requirements. Alternative embodiments may omit one or more of the phases depicted in FIG. 4, may execute phases in a different order, may perform phases concurrently rather than sequentially, or may include additional phases not explicitly shown in FIG. 4. For example, some quantum neural network training workflows may bypass the inference and output phase 416 during iterative training cycles, while some inference-only workloads may omit the parameter adjustment phase 410 and convergence/evaluation phase 414. The process flow 400 may serve as a representative framework for understanding how the dual-helix quantum architecture may support end-to-end quantum AI computation, but the architecture itself may support a wide variety of computational workflows beyond the specific example illustrated in FIG. 4.

### ILLUSTRATIVE METHODS

FIGS. 5-9 illustrate example methods that may be performed using the disclosed architecture. These methods demonstrate how quantum computations may be organized, scheduled, and executed using spatially organized quantum nodes.

The illustrated methods are non-limiting and may be modified, reordered, combined, or omitted depending on the specific application. The disclosed architecture does not require execution of any particular method unless expressly claimed.

FIG. 5 depicts a flowchart of a method 500 for quantum computing, arranged in accordance with at least one embodiment described herein. The method 500 may be programmably performed or controlled by a processor in, e.g., a computer and/or server coupled to the classical computing interface 122. In an example implementation, the method 500 may be performed in whole or in part by the system 100 of FIG. 1A under the control of a classical processor (coupled to the classical computing interface 122). Some embodiments herein may include a non-transitory computer-readable storage medium that includes computer-executable instructions executable by a processor device to perform or control performance of any operations herein, such as the operations of the method 500 of FIG. 5. The method 500 may include one or more of blocks 502, 504, and/or 506.

The method 500 may begin at block 502. At block 502, spatial coordinates may be obtained for each of one or more quantum nodes positioned along two intertwined helices of a quantum computing architecture. The spatial coordinates may be based on angular positions of the quantum nodes along the intertwined helices. Each quantum node may be assigned a deterministic spatial coordinate (xi, yi, zi) derived from an angular position θi according to parametric equations xi=r·cos(θi), yi=r·sin(θi), and zi=(h/2π)·θi, where r denotes the helix radius, h denotes the pitch, and θi=i·Δθ represents the angular coordinate of node i. The angular step Δθ may determine the node density along each helical strand. The spatial coordinate θi may function simultaneously as a logical register within a quantum state representation and as a physical address identifying the geometric location of the node within the three-dimensional helical structure.

The spatial coordinates may be obtained from a configuration file or data structure that stores the geometric parameters of the double-helix architecture. The geometric parameters may include the radius r, the pitch h, and the angular step Δθ. In some embodiments, the spatial coordinates may be calculated at initialization time and stored in a lookup table for efficient access during quantum circuit execution. Alternatively, the spatial coordinates may be computed on-demand based on the node index i and the geometric parameters.

At block 504, a quantum state may be prepared on at least one of the quantum nodes. The quantum state may include a positional mode with a value that corresponds to the spatial coordinate of the at least one of the quantum nodes. For example, a positional mode may correspond to angular coordinate θ and may be embedded into the quantum state via a phase tagging operation. A positional-phase tagging operator Upos(k) may be applied to each quantum state, where the operator takes the form Upos(k)=exp(ikθi) for a given spatial frequency parameter k.

At block 506, one or more quantum computations may be performed on the quantum state stored on the at least one of the quantum nodes. The quantum computations may include applying quantum gates, performing measurements, and processing the measurement outcomes to generate computational results. The quantum gates may include single-qubit gates and two-qubit gates that transform the quantum states according to unitary operations.

In some embodiments, neighboring quantum nodes may be selected based on the positional mode of the at least one of the quantum nodes and the neighboring quantum nodes. The selection may restrict gate connections for the at least one of the quantum nodes to the neighboring quantum nodes. The neighboring quantum nodes may be defined as nodes positioned at adjacent angular coordinates along the same helical strand or nodes positioned on different helical strands but at substantially the same angular position. In some embodiments, operations of the gate connections may be organized in a sublayer of the quantum computations so that no quantum node is involved in more than one gate operation per sublayer of the quantum computing architecture.

In some embodiments, operations for a plurality of sublayers in the quantum computing architecture may be performed in parallel. The parallel execution may occur when the sublayers correspond to different segments of the helical structure that do not share any common quantum nodes. Each segment may comprise a contiguous group of quantum nodes along one of the helical strands.

In some embodiments, execution includes configuring one or more control parameter values associated with quantum gate operations. Control parameter values may include rotation angles, coupling strengths, and phase offsets. Control parameter values may be assigned per node or shared across nodes within a segment to reduce configuration overhead.

In some embodiments, a common control parameter value for a segment is determined based on calibration values, measurement results, or other execution metrics obtained from nodes in the segment. The common control parameter value may be broadcast to nodes within the segment prior to executing a subsequent scheduling interval.

In some embodiments, the quantum nodes in the segment may each include a plurality of trainable parameter types that are updated. During the quantum computations, the value for each trainable parameter type may be updated to the same value across all the quantum nodes in the segment such that for each trainable parameter type all quantum nodes in the segment are updated to the same value. For example, a first parameter type may control rotation angles for Ry gates, a second parameter type may control rotation angles for Rz gates, and a third parameter type may control coupling strengths for entangling gates. The segment-scoped parameter tying mechanism may be applied independently to each parameter type. For each parameter type, the local gradients for that parameter type may be aggregated across all nodes in the segment to produce a segment-averaged gradient for that parameter type. The segment-averaged gradient may then be used to update the shared parameter value for that parameter type within the segment.

One skilled in the art will appreciate that, for this and other processes and methods disclosed herein, the functions performed in the processes and methods may be implemented in differing order. Further, the outlined steps and operations are only provided as examples, and some of the steps and operations may be optional, combined into fewer steps and operations, or expanded into additional steps and operations without detracting from the essence of the disclosed embodiments.

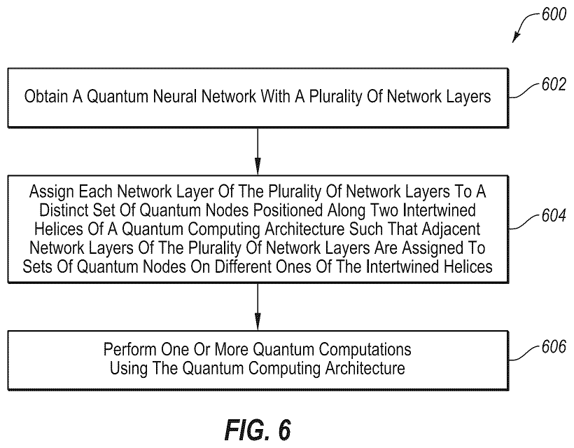

FIG. 6 depicts a flowchart of a method 600 for quantum computing, arranged in accordance with at least one embodiment described herein. The method 600 may be programmably performed or controlled by a processor in, e.g., a computer and/or server coupled to the classical computing interface 122. In an example implementation, the method 600 may be performed in whole or in part by the system 100 of FIG. 1A under the control of a classical processor (coupled to the classical computing interface 122). Some embodiments herein may include a non-transitory computer-readable storage medium that includes computer-executable instructions executable by a processor device to perform or control performance of any operations herein, such as the operations of the method 600 of FIG. 6.

At block 602, a quantum neural network with a plurality of network layers may be obtained. The quantum neural network may represent a computational model comprising multiple sequential or interconnected layers that perform quantum operations on input data.

At block 604, each network layer of the plurality of network layers may be assigned to a distinct set of quantum nodes positioned along two intertwined helices of a quantum computing architecture. The assignment may be performed such that adjacent network layers of the plurality of network layers are assigned to sets of quantum nodes on different ones of the intertwined helices. Adjacent network layers may be layers that are consecutive in an ordered sequence of layers in the quantum neural network. The ordered sequence may represent the forward propagation path through the network during inference or the combined forward and backward propagation paths during training.

The assignment process may begin by determining a number of quantum nodes required for a first network layer. The determination may be based on the width of the layer, which may correspond to the number of neurons or quantum processing elements required to represent the layer's computational capacity. A first set of quantum nodes on a first helix of the intertwined helices may be selected, where the number of quantum nodes in the first set equals the determined number of quantum nodes for the first network layer. The first set of quantum nodes may comprise contiguous quantum nodes on the first helix. Contiguous quantum nodes may be positioned at consecutive angular positions along the helical structure without gaps in the angular coordinate sequence.

For a second network layer adjacent to the first network layer, a number of quantum nodes required for the second network layer may be determined. A second set of quantum nodes on a second helix of the intertwined helices may be selected, where the number of quantum nodes in the second set equals the determined number of quantum nodes for the second network layer. The alternating assignment of consecutive layers between the first helix and the second helix may enable efficient inter-layer communication through cross-strand rung connections while maintaining spatial locality within each layer.

The alternating assignment may be implemented according to a mapping strategy wherein odd-numbered layers are assigned to nodes on the first helix chain while even-numbered layers are assigned to nodes on the second helix chain. Layer 1 may be mapped to a contiguous segment of nodes on helix chain A. Layer 2 may be mapped to a corresponding segment on helix chain B. Layer 3 may return to helix chain A. Layer 4 may return to helix chain B. The alternating pattern may continue for all layers in the network. This mapping is illustrative and may be used to support spatial pipelining in which different stages execute in overlapping time windows subject to scheduling constraints that avoid node contention.

Quantum connections may be formed between different sets of quantum nodes on different ones of the intertwined helices. These quantum connections may be implemented through rung couplers that provide direct quantum communication channels between nodes on the first helix and nodes on the second helix. In some embodiments, rung couplers may operate bidirectionally, enabling both forward data flow and backward gradient flow within the same physical interconnect structure. Trainable parameters associated with a network layer of the plurality of network layers may be mapped to quantum connections between quantum nodes of the set of quantum nodes to which the network layer is assigned.

At block 606, one or more quantum computations may be performed using the quantum computing architecture. The quantum computations may include applying quantum gates to quantum nodes, performing measurements, and collecting results according to the schedules and mappings established during the assignment process. The quantum computations may leverage the spatial topology of the double-helix structure to enable parallel execution of quantum operations across multiple segments while maintaining coherence and minimizing errors.

In some embodiments, quantum computations include applying local operations at one or more quantum nodes and applying inter-node operations between neighboring nodes. Local operations may include single-qubit gates and parameterized rotations. Inter-node operations may include entangling gates executed between helical neighbors or between cross-strand node pairs coupled by rung couplers. In some embodiments, measurement outcomes are collected and processed by classical control circuitry to support execution coordination, scheduling updates, and/or error management.

In some embodiments, the quantum computations may include applying activation functions locally at one or more of the quantum nodes. The activation functions may introduce nonlinearity into the quantum circuit, which may be required for the quantum neural network to approximate complex functions. The activation functions may be implemented through measurement-based feedback, phase kickback mechanisms, or parameterized rotation gates. Example activation behaviors may be approximated using rotation gates, phase-based transformations, or measurement-conditioned operations, including non-linear response functions. Adaptive activation functions may use phase shifts that are learned during training. The quantum computations may include passing gradient information along bidirectional channels between the sets of quantum nodes along the intertwined helices.

The quantum computations may include two or more sets of quantum nodes on a helix of the intertwined helices forming a spatial data pipeline. For example, while a first set of nodes executes a first circuit stage, a second set of nodes may execute a second circuit stage, such that different regions of the dual-helix structure execute different stages concurrently in space. Spatial pipelining may be coordinated using scheduling intervals and segment boundaries to prevent resource conflicts. In this disclosure, adjacency and inter-layer communication between quantum nodes are determined based on angular proximity of quantum nodes along the two intertwined helices (e.g., the A-helix chain and B-helix chain shown in FIG. 2) and by quantum-mechanical coupling between quantum nodes positioned at corresponding or near-corresponding angular positions on different ones of the two intertwined helices. In the example shown in FIG. 2, the A2 and B6 nodes have corresponding angular positions; A3 node and the B7 node have corresponding angular positions; and so forth for other nodes in the two helix chains. In some examples, the nearby nodes can have near-corresponding angular positions. For example, A2 and B7 nodes have near-corresponding angular positions; B6 and A3 have near-corresponding angular positions; and so forth. In one example, the nodes having near-corresponding angular positions are within an angular range sufficient to support inter-helix coupling or inter-layer communication. Such an angular range may vary by hardware, scheduling policy, and/or control constraints. Thus, such angular range may vary and may be dynamically determined. In other examples, the nodes having near-corresponding angular positions may have a fixed or variable threshold. If the difference of the angular positions of two nodes from the two helix chains is greater than such a threshold, the nodes are treated as having near-corresponding angular positions or corresponding angular positions.

One skilled in the art will appreciate that, for this and other processes and methods disclosed herein, the functions performed in the processes and methods may be implemented in differing order. Further, the outlined steps and operations are only provided as examples, and some of the steps and operations may be optional, combined into fewer steps and operations, or expanded into additional steps and operations without detracting from the essence of the disclosed embodiments.

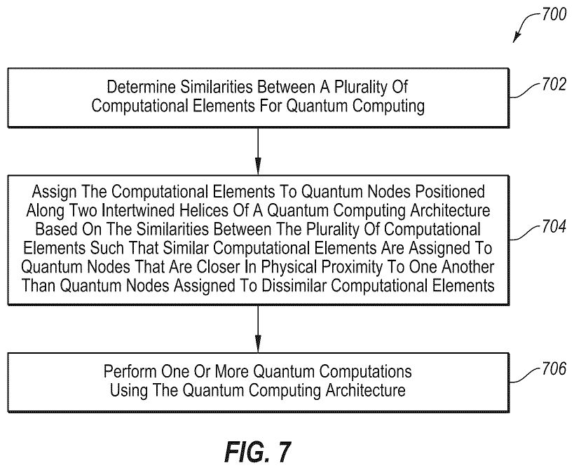

FIG. 7 depicts a flowchart of a method 700 for quantum computing, arranged in accordance with at least one embodiment described herein. The method 700 may be programmably performed or controlled by a processor in, for example, a computer or server coupled to the classical computing interface 122 of FIG. 1A. In an example implementation, the method 700 may be performed in whole or in part by the system 100 of FIG. 1A under the control of a classical processor coupled to the classical computing interface 122. Some embodiments herein may include a non-transitory computer-readable storage medium that includes computer-executable instructions executable by a processor device to perform or control performance of any operations herein, such as the operations of the method 700 of FIG. 7.

The method 700 may begin at block 702. At block 702, similarities may be determined between a plurality of computational elements for quantum computing. The computational elements may include data from a dataset or variables from a computational model. For data-based computational elements, each element may correspond to a feature vector, a data point, or a tensor component from an input dataset. For model-based computational elements, each element may correspond to a weight parameter, a bias term, or a trainable coefficient within a quantum neural network or variational quantum circuit. In some embodiments, relationships are quantified using a distance metric, correlation metric, dependency metric, or connectivity score representing expected interaction between computational elements during circuit execution. For example, the similarity between computational elements may be quantified using a similarity function that measures the degree of relatedness or correlation between pairs of elements. For data vectors, the similarity function may compute a distance metric such as Euclidean distance, cosine similarity, or kernel-based similarity measures. For model variables, the similarity may be determined by computing connectivity scores that reflect the frequency or strength of interactions between variables during computational operations. The connectivity score for a variable may be calculated by summing the absolute values of coupling coefficients between that variable and all other variables in the model.

In some embodiments, the determination of similarities may involve constructing a similarity graph where nodes represent computational elements and edges represent similarity relationships exceeding a threshold value. Alternatively or additionally, the determination may involve computing a pairwise similarity matrix where each entry represents the similarity between a pair of computational elements.

At block 704, the computational elements may be assigned to quantum nodes positioned along two intertwined helices of a quantum computing architecture based on the similarities between the plurality of computational elements. The assignment may be performed such that similar computational elements are assigned to quantum nodes that are closer in physical proximity to one another than quantum nodes assigned to dissimilar computational elements. The assignment process may utilize the deterministic spatial coordinates of quantum nodes along the helical structure to assign computational elements to specific quantum nodes based on the spatial coordinate of that node along the helical structure. Alternately or additionally, in some embodiments, elements expected to interact frequently are assigned to quantum nodes having smaller angular separation or to nodes coupled by rung connections to reduce routing overhead during execution.

In some embodiments, computational elements are ordered prior to assignment so that related elements are assigned to nearby angular positions along a helix. The ordered elements may be mapped sequentially to quantum nodes such that locality of the ordering corresponds to geometric locality of the node topology. For example, the ordering process may arrange elements such that elements with higher mutual similarity are positioned earlier in the sorted sequence.

In some embodiments, similar computational elements may be assigned to quantum nodes on the same helix of the two intertwined helices. The assignment to a single helix may reduce the physical distance between quantum nodes storing similar computational elements, thereby minimizing the number of cross-helix operations required during quantum computations. For example, the quantum nodes on the first helix chain 102A may store a first subset of computational elements that exhibit high mutual similarity, while the quantum nodes on the second helix chain 102B may store a second subset of computational elements that exhibit high mutual similarity within the second subset but lower similarity to elements in the first subset. In other embodiments, assignment alternates between helices to enable cross-strand entangling operations via rung couplers, depending on circuit structure and scheduling constraints.

At block 706, one or more quantum computations may be performed using the quantum computing architecture. The quantum computations may include applying quantum gates to quantum nodes, performing measurements, and collecting results according to the schedules and mappings established during the assignment process.

In some embodiments, measurement results collected during execution are used by a control system to update scheduling decisions, segment allocations, and/or configuration values for subsequent execution intervals. Such updates may be based on measured error rates, fidelity estimates, routing contention indicators, or other execution metrics.

In some embodiments, segment-level aggregation of measurement results is performed to produce segment-level metrics used to coordinate execution. Segment-level metrics may be combined across segments to produce global execution metrics that inform schedule revision, segment reconfiguration, or error mitigation actions.

One skilled in the art will appreciate that, for this and other processes and methods disclosed herein, the functions performed in the processes and methods may be implemented in differing order. Further, the outlined steps and operations are only provided as examples, and some of the steps and operations may be optional, combined into fewer steps and operations, or expanded into additional steps and operations without detracting from the essence of the disclosed embodiments.

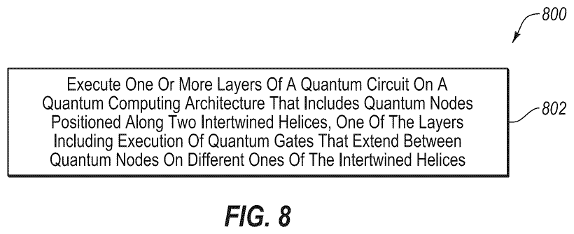

FIG. 8 depicts a flowchart of a method 800 for quantum computing using a dual-helix quantum architecture, arranged in accordance with at least one embodiment described herein. The method 800 may be programmably performed or controlled by a processor in, for example, a computer or server coupled to the classical computing interface 122 of FIG. 1A. In an example implementation, the method 800 may be performed in whole or in part by the system 100 of FIG. 1A under the control of a classical processor coupled to the classical computing interface 122. Some embodiments herein may include a non-transitory computer-readable storage medium that includes computer-executable instructions executable by a processor device to perform or control performance of any operations herein, such as the operations of the method 800 of FIG. 8.

The method 800 may begin at block 802. At block 802, one or more layers of a quantum circuit may be executed on a quantum computing architecture that includes quantum nodes positioned along two intertwined helices. One of the layers may include execution of quantum gates that extend between quantum nodes on different ones of the intertwined helices via rung couplers. In some embodiments, the quantum computing architecture may comprise the dual-helix structure 102 of FIG. 1A.

The execution of one or more layers of the quantum circuit may involve applying quantum gates to quantum states stored at the quantum nodes. In some embodiments, only a single quantum operation is performed at each quantum node during execution of any one layer, preventing a node from participating in multiple gate operations simultaneously. In some embodiments, gate operations are organized into sublayers using an edge-coloring algorithm applied to a connectivity graph so that no two gates in a sublayer share a quantum node, enabling parallel execution of all gates in the sublayer.

In some embodiments, a second layer of the one or more layers may include execution of quantum gates that extend between physically adjacent quantum nodes along the same helix. Physically adjacent quantum nodes may be quantum nodes positioned at consecutive angular positions along the helical structure without gaps in the angular coordinate sequence. The second layer may be executed before the one of the layers that includes quantum gates extending between quantum nodes on different helices. In some embodiments, a third layer of the one or more layers may include execution of single qubit gates. The third layer may be executed before the second layer.

One skilled in the art will appreciate that, for this and other processes and methods disclosed herein, the functions performed in the processes and methods may be implemented in differing order. Further, the outlined steps and operations are only provided as examples, and some of the steps and operations may be optional, combined into fewer steps and operations, or expanded into additional steps and operations without detracting from the essence of the disclosed embodiments.

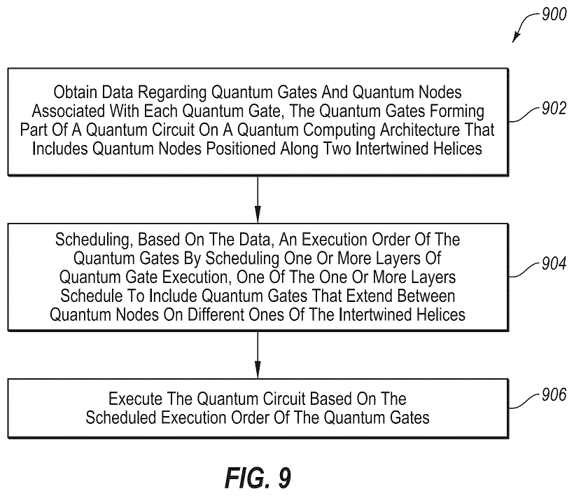

FIG. 9 depicts a flowchart of a method 900 for quantum computing using a dual-helix quantum architecture, arranged in accordance with at least one embodiment described herein. The method 900 may be programmably performed or controlled by a processor in, for example, a computer or server coupled to the classical computing interface 122 of FIG. 1A. In an example implementation, the method 900 may be performed in whole or in part by the system 100 of FIG. 1A under the control of a classical processor coupled to the classical computing interface 122. Some embodiments herein may include a non-transitory computer-readable storage medium that includes computer-executable instructions executable by a processor device to perform or control performance of any operations herein, such as the operations of the method 900 of FIG. 9.

The method 900 may begin at block 902. At block 902, data regarding quantum gates and quantum nodes associated with each quantum gate may be obtained. The quantum gates may form part of a quantum circuit on a quantum computing architecture that includes quantum nodes positioned along two intertwined helices. The quantum computing architecture may comprise the dual-helix structure 102 of FIG. 1A. The quantum nodes may be positioned along the first helix chain 102A and the second helix chain 102B.

The data regarding quantum gates may include gate type, target node identifiers, control node identifiers, and any parameters associated with each gate. The data regarding quantum nodes may include spatial coordinates, angular positions along a helix, and helix membership. The data may be obtained from a circuit specification and/or produced by a compiler configured to map a logical circuit to the physical topology.

At block 904, an execution order of the quantum gates may be scheduled based on the data. The scheduling may organize the quantum gates into one or more layers of quantum gate execution. One of the one or more layers may be scheduled to include quantum gates that extend between quantum nodes on different ones of the intertwined helices. The scheduling process may determine the temporal sequence in which quantum gates are executed and may group gates into layers such that gates within a layer may be executed in parallel without conflicts.

The scheduling process may classify quantum gates based on the physical distance between the quantum nodes involved in each gate operation. For example, single-qubit gates may be assigned to an early layer, two-qubit gates between helical neighbor nodes may be assigned to a second layer, cross-strand rung gates may be assigned to a third layer, and long-range gates requiring multi-hop routing or quantum state transfer techniques may be assigned to a later layer.

In some embodiments, scheduling incorporates positional information associated with quantum nodes. For example, a positional mode may represent angular coordinate θi of a node, and gates connecting nodes with similar θ values may be preferentially scheduled earlier or grouped to reduce routing distance and contention.

Gates connecting nodes with dissimilar positional modes may be assigned to later layers, and scheduling may further incorporate segment boundaries such that intra-segment gates are scheduled earlier and inter-segment gates are scheduled later, enabling concurrent execution across segments while controlling inter-segment contention.

The scheduling process may incorporate information about segment boundaries when determining gate assignments to layers. The dual-helix structure may be divided into segments, where each segment comprises a contiguous group of quantum nodes along a helical strand and segment boundaries are defined by angular positions along the helix. In some embodiments, gates that connect nodes within a same segment are assigned to earlier layers, and gates that connect nodes in different segments are assigned to later layers, thereby enabling parallel intra-segment execution while controlling inter-segment contention.

At block 906, the quantum circuit may be executed based on the scheduled execution order of the quantum gates. The execution may involve applying quantum gates to quantum states stored at the quantum nodes according to the scheduled sequence of layers and sublayers. The quantum gates may transform the quantum states according to unitary operations parameterized by the gate parameters specified in the quantum circuit specification.

The execution of the first layer may involve applying single-qubit gates to individual quantum nodes. The single-qubit gates may be applied in parallel across all quantum nodes that require such operations. The execution of the second layer may involve applying two-qubit gates between helical neighbor nodes. The execution of the third layer may involve applying cross-strand rung gates between quantum nodes on different helical strands. The execution of the fourth layer may involve implementing long-range gates through quantum state transfer techniques or multi-hop routing.

The execution of quantum gates may be coordinated by multiple components of the quantum computing system 100. The central control module 108 may coordinate the timing of gate operations across multiple quantum nodes. The task scheduler 110 may determine which quantum nodes execute which gates during each layer. The sensors 114 may monitor the fidelity of gate operations. The error correction module 106 may detect and correct errors that occur during gate execution.

The scheduling process may incorporate dynamic adjustments based on real-time feedback from the quantum hardware. If a particular quantum node or connection exhibits degraded performance, the scheduling process may reassign gates involving that node or connection to alternative nodes or connections. The dynamic adjustment may involve re-running the edge-coloring algorithm with updated connectivity information that excludes or deprioritizes the degraded elements.

One skilled in the art will appreciate that, for this and other processes and methods disclosed herein, the functions performed in the processes and methods may be implemented in differing order. Further, the outlined steps and operations are only provided as examples, and some of the steps and operations may be optional, combined into fewer steps and operations, or expanded into additional steps and operations without detracting from the essence of the disclosed embodiments.

### HARDWARE AND IMPLEMENTATION VARIANTS

The quantum computing architecture described herein may be realized through various physical implementations. Different quantum node architectures may be employed depending on the specific application requirements, operational environment, and available fabrication technologies. The choice of implementation may affect parameters such as coherence time, gate fidelity, operating temperature, and scalability, but the fundamental principles of the double-helix topology remain applicable across platforms. Note that the disclosed techniques related to implementing AI on quantum hardware are not limited to any specific hardware platform.

Furthermore, control systems, such as those described with respect to FIG. 1A that may be used with dual-helix architecture, may include classical processors, field-programmable gate arrays (FPGAs), application-specific integrated circuits (ASICs), or hybrid control systems. Quantum and classical components may communicate using wired or wireless interconnects. Any language directed to a computer includes any suitable combination of computing devices or network platforms, including servers, interfaces, systems, databases, agents, engines, controllers, and modules operating individually or collectively. Computing devices may include a processor configured to execute software instructions stored on a tangible, non-transitory computer-readable medium. Data exchanges among devices may be conducted over one or more networks including the Internet, LAN, WAN, VPN, packet-switched networks, circuit-switched networks, or other suitable networks.

### GENERAL ADVANTAGES

The spatial organization and execution framework described herein may provide one or more advantages, including improved scalability, reduced routing overhead, increased parallelism, and flexibility in supporting diverse quantum algorithms. Such advantages may vary depending on the implementation and workload.

### NON-LIMITING EMBODIMENTS AND COMBINATIONS

Further, note that features described in connection with one or more embodiments may be omitted, substituted, or combined with features of other embodiments unless the context indicates otherwise. The scope of the disclosure is defined solely by the claims.

Throughout the specification and claims, the following terms take the meanings explicitly associated herein, unless the context clearly dictates otherwise. The phrase “in one embodiment” as used herein does not necessarily refer to the same embodiment, though it may. Thus, as described below, various embodiments of the disclosure may be readily combined, without departing from the scope or spirit of the invention. As used herein, the term “or” is an inclusive “or” operator and is equivalent to the term “and/or,” unless the context clearly dictates otherwise. The term “based on” is not exclusive and allows for being based on additional factors not described unless the context clearly dictates otherwise.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of a networked environment where two or more components or devices are able to exchange data, the terms “coupled to” and “coupled with” are also used to mean “communicatively coupled with”, possibly via one or more intermediary devices. The components or devices can be optical, mechanical, and/or electrical devices.

Although the following description uses terms “first,” “second,” etc. to describe various elements, these elements should not be limited by the terms. These terms are only used to distinguish one element from another. For example, a first sensor could be termed a second sensor and, similarly, a second sensor could be termed a first sensor, without departing from the scope of the various described examples. The first sensor and the second sensor can both be sensors and, in some cases, can be separate and different sensors. In addition, throughout the specification, the meaning of “a”, “an”, and “the” includes plural references, and the meaning of “in” includes “in” and “on”.

Although some of the various embodiments presented herein constitute a single combination of inventive elements, it should be appreciated that the inventive subject matter is considered to include all possible combinations of the disclosed elements. As such, if one embodiment comprises elements A, B, and C, and another embodiment comprises elements B and D, then the inventive subject matter is also considered to include other remaining combinations of A, B, C, or D, even if not explicitly discussed herein. Further, the transitional term “comprising” means to have as parts or members, or to be those parts or members. As used herein, the transitional term “comprising” is inclusive or open-ended and does not exclude additional, unrecited elements or method steps.

As used in the description herein and throughout the claims that follow, when a system, engine, server, device, module, or other computing element is described as being configured to perform or execute functions on data in a memory, the meaning of “configured to” or “programmed to” is defined as one or more processors or cores of the computing element being programmed by a set of software instructions stored in the memory of the computing element to execute the set of functions on target data or data objects stored in the memory.

It should be noted that any language directed to a computer should be read to include any suitable combination of computing devices or network platforms, including servers, interfaces, systems, databases, agents, peers, engines, controllers, modules, or other types of computing devices operating individually or collectively. One should appreciate the computing devices comprise a processor configured to execute software instructions stored on a tangible, non-transitory computer readable storage medium (e.g., hard drive, FPGA, PLA, solid state drive, RAM, flash, ROM, or any other volatile or non-volatile storage devices). The software instructions configure or program the computing device to provide the roles, responsibilities, or other functionality as discussed below with respect to the disclosed apparatus. Further, the disclosed technologies can be embodied as a computer program product that includes a non-transitory computer readable medium storing the software instructions that causes a processor to execute the disclosed steps associated with implementations of computer-based algorithms, processes, methods, or other instructions. In some embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges among devices can be conducted over a packet-switched network, the Internet, LAN, WAN, VPN, or other type of packet switched network; a circuit switched network; cell switched network; or other type of network.

### ADDITIONAL EXAMPLES

1. A method comprising:
obtaining a quantum neural network with a plurality of network layers;
assigning each network layer of the plurality of network layers to a distinct set of quantum nodes physically arranged along two intertwined helices extending along a longitudinal axis of a quantum computing architecture such that adjacent network layers of the plurality of network layers are assigned to sets of quantum nodes on different ones of the two intertwined helices and are quantum-mechanically coupled via inter-helix quantum couplers; and
performing one or more quantum computations including executing distributed quantum gate operations across the sets of quantum nodes using the quantum computing architecture, wherein adjacency and inter-layer communication between quantum nodes are determined based on angular proximity of quantum nodes along the two intertwined helices and by quantum-mechanical coupling between quantum nodes positioned at corresponding or near-corresponding angular positions on different ones of the two intertwined helices.

2. The method of embodiment 1, wherein adjacent network layers are layers that are consecutive in an ordered sequence of layers in the quantum neural network.

3. The method of any of embodiments 1-2, wherein assigning each network layer of the plurality of network layers to a distinct set of quantum nodes includes:
determining a number of quantum nodes for a first network layer; and
selecting a first set of quantum nodes on a first helix of the intertwined helices with a number of quantum nodes equal to the determined number of quantum nodes for the first network layer.

4. The method of embodiment 3, wherein the first set of quantum nodes are contiguous quantum nodes on the first helix.

5. The method of any of embodiments 3-4, wherein assigning each network layer of the plurality of network layers to a distinct set of quantum nodes further includes:
determining a number of quantum nodes for a second network layer adjacent to the first network layer; and
selecting a second set of quantum nodes on a second helix of the intertwined helices with a number of quantum nodes equal to the determined number of quantum nodes for the second network layer.

6. The method of any of embodiments 1-5, further comprising forming a quantum connection between different sets of quantum nodes on different ones of the intertwined helices.

7. The method of any of embodiments 1-6, further comprising mapping operation parameters associated with a network layer of the plurality of network layers to quantum connections between quantum nodes of the set of quantum nodes to which the network layer is assigned.

8. The method of any of embodiments 1-7, wherein performing one or more quantum computations using the quantum computing architecture includes applying activation functions locally at one or more of the quantum nodes.

9. The method of any of embodiments 1-8, wherein performing one or more quantum computations using the quantum computing architecture includes passing gradient information along bi-directional channels between the sets of quantum nodes along the intertwined helices.

10. The method of any of embodiments 1-9, wherein performing one or more quantum computations using the quantum computing architecture includes two or more sets of quantum nodes on a helix of the intertwined helices forming a spatial data pipeline.

11. A quantum computing system comprising:
a plurality of quantum nodes physically arranged along two intertwined helices extending along a longitudinal axis of a quantum computing architecture;
a quantum processing system configured to:
   assign each network layer of a plurality of network layers of a quantum neural network to a distinct set of quantum nodes positioned along the intertwined helices such that adjacent network layers of the plurality of network layers are assigned to sets of quantum nodes on different ones of the intertwined helices and are operatively coupled via inter-helix quantum couplers; and
   perform one or more quantum computations including executing quantum gate operations distributed across the sets of quantum nodes using the quantum computing architecture, wherein adjacency and inter-layer communication between quantum nodes are determined by angular proximity along the two intertwined helices and by quantum coupling between quantum nodes positioned at corresponding or near-corresponding angular positions on different ones of the two intertwined helices.

12. The quantum computing system of embodiment 11, wherein adjacent network layers are layers that are consecutive in an ordered sequence of layers in the quantum neural network.

13. The quantum computing system of any of embodiments 11-12, wherein assigning each network layer of the plurality of network layers to a distinct set of quantum nodes includes:
determining a number of quantum nodes for a first network layer; and
selecting a first set of quantum nodes on a first helix of the intertwined helices with a number of quantum nodes equal to the determined number of quantum nodes for the first network layer.

14. The quantum computing system of embodiment 13, wherein the first set of quantum nodes are contiguous quantum nodes on the first helix.

15. The quantum computing system of any of embodiments 13-14, wherein assigning each network layer of the plurality of network layers to a distinct set of quantum nodes further includes:
determining a number of quantum nodes for a second network layer adjacent to the first network layer; and
selecting a second set of quantum nodes on a second helix of the intertwined helices with a number of quantum nodes equal to the determined number of quantum nodes for the second network layer.

16. The quantum computing system of any of embodiments 11-15, further comprising a quantum connection between different sets of quantum nodes on different ones of the intertwined helices.

17. The quantum computing system of any of embodiments 11-16, wherein the quantum processing system is further configured to map trainable parameters associated with a network layer of the plurality of network layers to quantum connections between quantum nodes of the set of quantum nodes to which the network layer is assigned.

18. The quantum computing system of any of embodiments 11-17, wherein performing one or more quantum computations using the quantum computing architecture includes applying activation functions locally at one or more of the quantum nodes.

19. The quantum computing system of any of embodiments 11-18, wherein performing one or more quantum computations using the quantum computing architecture includes passing gradient information along bi-directional channels between the sets of quantum nodes along the intertwined helices.

20. The quantum computing system of any of embodiments 11-19, wherein performing one or more quantum computations using the quantum computing architecture includes two or more sets of quantum nodes on a helix of the intertwined helices forming a spatial data pipeline.

1. A method comprising:
obtaining a quantum neural network with a plurality of network layers;
assigning each network layer of the plurality of network layers to a distinct set of quantum nodes physically arranged along two intertwined helices extending along a longitudinal axis of a quantum computing architecture such that adjacent network layers of the plurality of network layers are assigned to sets of quantum nodes on different ones of the two intertwined helices and are quantum-mechanically coupled via inter-helix quantum couplers; and
performing one or more quantum computations including executing distributed quantum gate operations across the sets of quantum nodes using the quantum computing architecture, wherein adjacency and inter-layer communication between quantum nodes are determined based on angular proximity of quantum nodes along the two intertwined helices and by quantum-mechanical coupling between quantum nodes positioned at corresponding or near-corresponding angular positions on different ones of the two intertwined helices.

2. The method of claim 1, wherein adjacent network layers are layers that are consecutive in an ordered sequence of layers in the quantum neural network.

3. The method of claim 1, wherein assigning each network layer of the plurality of network layers to a distinct set of quantum nodes includes:
determining a number of quantum nodes for a first network layer; and
selecting a first set of quantum nodes on a first helix of the intertwined helices with a number of quantum nodes equal to the determined number of quantum nodes for the first network layer.

4. The method of claim 3, wherein the first set of quantum nodes are contiguous quantum nodes on the first helix.

5. The method of claim 3, wherein assigning each network layer of the plurality of network layers to a distinct set of quantum nodes further includes:
determining a number of quantum nodes for a second network layer adjacent to the first network layer; and
selecting a second set of quantum nodes on a second helix of the intertwined helices with a number of quantum nodes equal to the determined number of quantum nodes for the second network layer.

6. The method of claim 1, further comprising forming a quantum connection between different sets of quantum nodes on different ones of the intertwined helices.

7. The method of claim 1, further comprising mapping operation parameters associated with a network layer of the plurality of network layers to quantum connections between quantum nodes of the set of quantum nodes to which the network layer is assigned.

8. The method of claim 1, wherein performing one or more quantum computations using the quantum computing architecture includes applying activation functions locally at one or more of the quantum nodes.

9. The method of claim 1, wherein performing one or more quantum computations using the quantum computing architecture includes passing gradient information along bi-directional channels between the sets of quantum nodes along the intertwined helices.

10. The method of claim 1, wherein performing one or more quantum computations using the quantum computing architecture includes two or more sets of quantum nodes on a helix of the intertwined helices forming a spatial data pipeline.

11. A quantum computing system comprising:
a plurality of quantum nodes physically arranged along two intertwined helices extending along a longitudinal axis of a quantum computing architecture;
a quantum processing system configured to:
assign each network layer of a plurality of network layers of a quantum neural network to a distinct set of quantum nodes positioned along the intertwined helices such that adjacent network layers of the plurality of network layers are assigned to sets of quantum nodes on different ones of the intertwined helices and are operatively coupled via inter-helix quantum couplers; and
perform one or more quantum computations including executing quantum gate operations distributed across the sets of quantum nodes using the quantum computing architecture, wherein adjacency and inter-layer communication between quantum nodes are determined by angular proximity along the two intertwined helices and by quantum coupling between quantum nodes positioned at corresponding or near-corresponding angular positions on different ones of the two intertwined helices.

12. The quantum computing system of claim 11, wherein adjacent network layers are layers that are consecutive in an ordered sequence of layers in the quantum neural network.

13. The quantum computing system of claim 11, wherein assigning each network layer of the plurality of network layers to a distinct set of quantum nodes includes:
determining a number of quantum nodes for a first network layer; and
selecting a first set of quantum nodes on a first helix of the intertwined helices with a number of quantum nodes equal to the determined number of quantum nodes for the first network layer.

14. The quantum computing system of claim 13, wherein the first set of quantum nodes are contiguous quantum nodes on the first helix.

15. The quantum computing system of claim 13, wherein assigning each network layer of the plurality of network layers to a distinct set of quantum nodes further includes:
determining a number of quantum nodes for a second network layer adjacent to the first network layer; and
selecting a second set of quantum nodes on a second helix of the intertwined helices with a number of quantum nodes equal to the determined number of quantum nodes for the second network layer.

16. The quantum computing system of claim 11, further comprising a quantum connection between different sets of quantum nodes on different ones of the intertwined helices.

17. The quantum computing system of claim 11, wherein the quantum processing system is further configured to map trainable parameters associated with a network layer of the plurality of network layers to quantum connections between quantum nodes of the set of quantum nodes to which the network layer is assigned.

18. The quantum computing system of claim 11, wherein performing one or more quantum computations using the quantum computing architecture includes applying activation functions locally at one or more of the quantum nodes.

19. The quantum computing system of claim 11, wherein performing one or more quantum computations using the quantum computing architecture includes passing gradient information along bi-directional channels between the sets of quantum nodes along the intertwined helices.

20. The quantum computing system of claim 11, wherein performing one or more quantum computations using the quantum computing architecture includes two or more sets of quantum nodes on a helix of the intertwined helices forming a spatial data pipeline.
